(19) United States
(12) Patent Application Publication
(10) Pub. No.: US 2005/0235561 A1
(43) Pub. Date: Oct. 27, 2005

(54) Door wedge

(76) Inventor: Richard D. Bushey, Kenosha, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/109,367

(22) Filed: Apr. 19, 2005

Related U.S. Application Data
(60) Provisional application No. 60/564,038, filed on Apr. 21, 2004.

(51) Int. Cl. E06B 7/00

(52) U.S. Cl. 49/70

(57) ABSTRACT

A door wedge is provided for maintaining a door at a user desired position. The door wedge includes a flexible bridge member extending along a bridge axis. The bridge has an upper surface for engaging a bottom surface of the door, as well as, first and second opposite ends. The bridge is movable between a first flexed configuration wherein the bridge has a generally crescent shaped cross-section and a second non-flexed position wherein the bridge is generally flat. A first support has a first end operatively connected to a first end of the bridge and a second free end disposed beneath the first end of the first support. A second support has a first end operatively connected to the second end of the bridge and a second free end disposed beneath the first end of the second support. The first and second supports maintain the upper surface of the bridge against the bottom of the door in order to maintain the door at the user desired position.

### CROSS-REFERENCE TO RELATED APPLICATIONS

This application claims the benefit of U.S. Provisional Application Ser. No. 60/564,038, filed Apr. 21, 2004.

### FIELD OF THE INVENTION

This invention relates generally to door stops, and in particular, to a door wedge that may be urged between the bottom portion of a conventional door and a supporting surface above which the door pivots in order to maintain the door at a user desired location.

### BACKGROUND AND SUMMARY OF THE INVENTION

As is known, various types of door props, door stops or door wedges have been developed to prevent a door from being opened or to maintain an open door at a user desired location. By way of example, Hoffman, U.S. Pat. No. 171,807 discloses a door-check for holding a door ajar. The door-check is formed from a rubber wedge having an upper, inclined surface. The inclined surface has a plurality of transverse ridges or waves formed therein. The base of the door-check is roughened or toothed. In operation, the lower surface of the door is pivoted over the inclined surface of the door-check and pressed over the crest or ridges of the waves in the inclined surface until such point as the bottom surface of the door engages a crest of sufficient height to arrest it. The roughened base of the door check prevents any tendency of the door-check to slip over a carpet.

While the door-check disclosed in the Hoffman '807 is functional for its intended purpose, the inclined surface of the door check disclosed therein has insufficient resiliency to catch and hold the door in the user desired location. Consequently, the door, intended to be held in the user desired position, may inadvertently become disengaged from the door-check, thereby freeing the door to once again pivot above the supporting surface.

In order to overcome the limitations disclosed in the Hoffman '807 patent, various means for anchoring a door in a set position have been considered. By way of example, Raber, U.S. Pat. No. 2,703,728 discloses a device expressly specifically for retaining a horizontal swingable door in a set position by anchoring the lower edge portion of a door to a conventional horizontal floor surface. The device includes a plate designed to underlie the lower surface of a conventional door. The plate includes shoulders that form blocks on opposite ends thereof and a leaf spring situated between the blocks. By exerting pressure on the leaf spring, the plate is urged into engagement with the bottom surface of the door so as to effectively fasten the device to the door and anchor the door to the supporting surface. Once again, while the Raber '728 patent is functional for its intended purpose, the device is somewhat complicated due to the numerous component parts. Further, due to the number of parts provided, the cost of the anchoring device disclosed in the Raber '728 patent is prohibitive.

Therefore, it is a primary object and feature of the present invention to provide a door wedge for retaining a door at a user desired selected location that is simple to utilize and inexpensive to manufacture.

It is a further object and feature of the present invention to provide a door wedge for retaining a door at a user selected location that may be utilized without damaging the door or the supporting surface above which the door pivots.

It is a still further object and feature of the present invention to provide a door wedge for retaining a door in a user selected position that accommodates variances in the spacing between the bottom of the door and the supporting surface above which the door pivots.

In accordance with the present invention, a door wedge is provided for maintaining a door at a user desired position. As is conventional, the door is pivotable over a supporting surface between an open position and a closed position. The door wedge includes a flexible bridge extending along a bridge axis and having an upper surface for engaging a bottom surface of the door and a lower surface. The bridge also includes first and second opposite ends. A first support is operatively connected to a first end of the bridge and has a passageway extending therethrough along a first support axis generally perpendicular to the bridge axis. A second support is operatively connected to the second end of the bridge and has a passageway extending therethrough along a second support axis generally perpendicular to the bridge axis.

The first support axis is generally parallel to the second support axis and the bridge is movable between a first flexed configuration wherein the bridge has a generally crescent shaped cross-section and a second non-flexed position wherein the bridge is generally flat. The first support has a first end integral with the first end of the bridge and a second free end. The second support has a first end integral with the second end of the bridge and a second free end. The second free end of the first support is positioned adjacent to the first end of the first support and the second free end of the second support is positioned adjacent to the first end of the second support. The first support includes an intermediate portion between the first and second ends thereof. Similarly, the second support includes an intermediate portion between the first and second ends thereof. The intermediate portion of the first support and the intermediate portion of the second support have a generally arcuate cross-sections. A first resilient pad may be affixed to the intermediate portion of the first support for engagement with the supporting surface and a second resilient pad may be affixed to the intermediate portion of the second support for engagement with the supporting surface.

In accordance with a further aspect of the present invention, a door wedge is provided for maintaining a door at a user desired position. As is conventional, the door is pivotable over a supporting surface between an open position and a closed position. The door wedge includes a flexible bridge extending along a bridge axis. The bridge has an upper surface for engaging a bottom surface of the door and a lower surface. The bridge also has first and second opposite ends and is movable between a first flexed configuration wherein the bridge has a generally crescent shaped cross-section and a second non-flexed position wherein the bridge is generally flat. A first support has a first end operatively connected to a first end of the bridge, a second free end disposed beneath the first end of the first support, and an intermediate portion therebetween. A second support has a first end operatively connected to the second end of the bridge, a second free end disposed beneath the first end of the second support and an intermediate portion therebetween.

The first support defines a passageway therethrough along a first support axis generally perpendicular to the bridge axis. The second support defines a passageway therethrough along a second support axis generally perpendicular to the bridge axis and generally parallel to first support axis. The first end of the first support is integral with the first end of the bridge and the first end of the second support is integral with the second end of the bridge. The intermediate portion of the first support and the intermediate portion of the second support have generally arcuate cross-sections. A first resilient pad may be affixed to the intermediate portion of the first support for engagement with the supporting surface and a second resilient pad may be affixed to the intermediate portion of the second support for engagement with the supporting surface.

In accordance with a still further aspect of the present invention, a door wedge is provided for maintaining a door at a user desired position. As is conventional, the door is pivotable over a supporting surface between an open position and a closed position. The door wedge includes a flexible bridge extending along a bridge axis and having an upper surface for engaging a bottom surface of the door and a lower surface. The bridge also includes first and second opposite ends and is movable between a first flexed configuration wherein the bridge has a generally crescent shaped cross-section and a second non-flexed position wherein the bridge is generally flat. A first generally cylindrical support has a first end operatively connected to a first end of the bridge, a second free end disposed beneath the first end of the first support, an arcuate intermediate portion therebetween, an inner surface and outer surface. A first anti-skid structure extends along the outer surface of the intermediate portion of the first support. A second generally cylindrical support has a first end operatively connected to the second end of the bridge, a second free end disposed beneath the first end of the second support, an arcuate intermediate portion therebetween, an inner surface and an outer surface. A second anti-skid structure extends along the outer surface of the intermediate portion of the second support.

The inner surface of the first support defines a passageway therethrough along a first support axis generally perpendicular to the bridge axis. Similarly, the second support defines a passageway therethrough along a second support axis generally perpendicular to the bridge axis and generally parallel to first support axis. The first end of the first support is integral with the first end of the bridge and the first end of the second support is integral with the second end of the bridge. The first anti-skid structure includes a first resilient pad affixed to the intermediate portion of the first support for engagement with the supporting surface. The second anti-skid structure includes a second resilient pad affixed to the intermediate portion of the second support for engagement with the supporting surface.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a cross-sectional view of a first embodiment of a door wedge in accordance with the present invention;

FIG. 2 is an isometric view showing the door wedge of FIG. 1 positioned beneath the bottom of a conventional door;

FIG. 3 is an enlarged isometric view, similar to FIG. 2, showing the first embodiment of the door wedge of the present invention positioned beneath the bottom of a conventional door;

FIG. 4 is a cross-sectional view showing a portion of a second embodiment of a door wedge in accordance with the present invention;

FIG. 5 is a cross-sectional view of a third embodiment of a door wedge in accordance with the present invention;

FIG. 6 is an enlarged isometric view showing the door wedge of FIG. 5 positioned beneath the bottom of a conventional door;

FIG. 7 is an isometric view of a fourth embodiment of a door wedge in accordance with the present invention;

FIG. 8 is an isometric view showing the door wedge of FIG. 7 positioned beneath the bottom of a conventional door;

FIG. 9 is an enlarged isometric view of the fourth embodiment of the door wedge positioned beneath the bottom of a conventional door;

FIG. 10 is an isometric view of a sixth embodiment of a door wedge in accordance with the present invention;

FIG. 11 is a side elevational view of a seventh embodiment of a door wedge in accordance of the present invention;

FIG. 12 is an isometric view of an eighth embodiment of a door wedge in accordance with the present invention;

FIG. 13 is an isometric view showing the door wedge of FIG. 12 positioned beneath the bottom of a conventional door;

FIG. 14 is an enlarged isometric view, similar to FIG. 13, showing the door wedge positioned beneath the bottom of a conventional door;

FIG. 15 is a top plan view of the door wedge of FIG. 12;

FIG. 16 is a side elevational view of the door wedge of FIG. 12;

FIG. 17 is an end view of the door wedge of FIG. 12; and

FIG. 18 is a bottom plan view of the door wedge of FIG. 12.

### DETAILED DESCRIPTION OF THE DRAWINGS

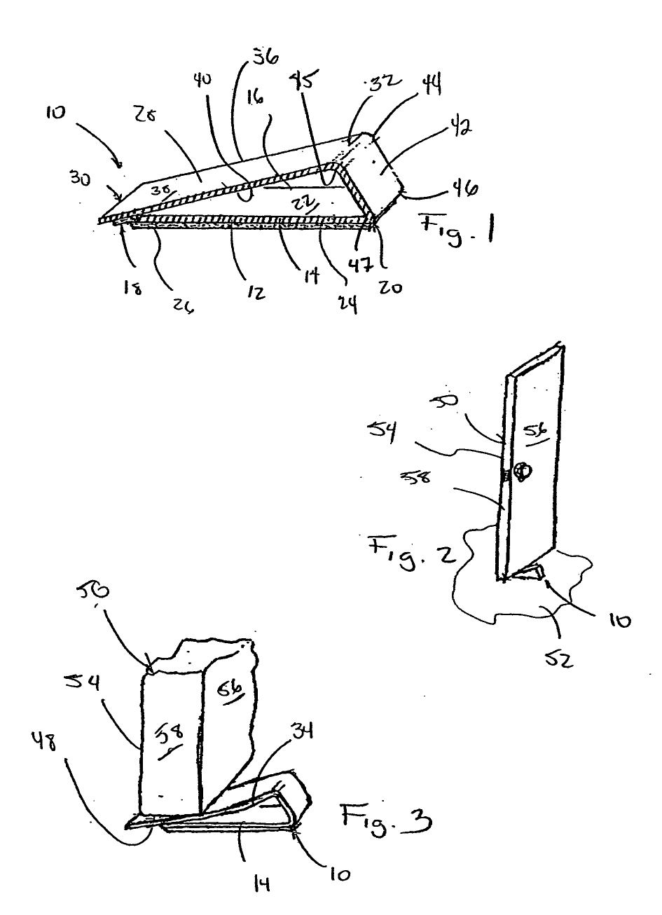

Referring to FIGS. 1-3, a door wedge in accordance with the present invention is generally designated by the reference numeral 10. Door wedge 10 includes a generally flat base 12 having first and second sides 14 and 16, respectively, and first and second ends 18 and 20, respectively. Base 12 further includes a generally flat upper surface 22 and a generally flat lower surface 24. A generally flat skid resistant pad 26 is affixed to lower surface 24 of base 12 along the entire length thereof between first and second sides 14 and 16, respectively.

Door wedge 10 further includes generally inclined plate 28 having first and second ends 30 and 32, respectively, and first and second sides 34 and 36, respectively. Inclined plate 28 is further defined by a generally flat upper surface 38 and a lower surface 40 directed towards upper surface 22 of base 12. A portion of lower surface 40 adjacent first end 30 of inclined plate 28 slidably engages upper surface 22 of base 12 adjacent first end 18 thereof, for reasons hereinafter described.

Door wedge 10 further includes a generally vertical wall 42 having a first upper end 44 integral with second end 32 of inclined plate 28 at intersection 45 and a second lower end 46 integral with 20 of base 12 at intersection 47. Intersection 45 of upper end 44 of vertical wall 22 and second end 32 of inclined plate 28 acts as a spring to bias upper plate 28 upwardly. Similarly, intersection 47 of the lower end 46 of vertical wall 42 and second end 20 of base 12 away from upper surface 22 of base 12, for reasons hereinafter described.

In operation, it is intended for door wedge 10 to be positioned between lower edge 48 of a conventional door 50 and a supporting surface such as floor 52 or the like. Door 50 is defined by faces 54 and 56 separated by an outer edge 58. Door wedge 10 is slid axially beneath door 50 such that upper surface 38 of inclined plate 28 engages lower edge 48 of door 50. In order to retain door 50 on door wedge 10, door 50 may be further pivoted onto upper surface 38 of inclined plate 28 towards vertical wall 42. Under the compressive force of lower edge 48 of door 50, inclined plate 28 is urged downwardly toward upper surface 22 of base 12. As described, lower surface 40 of inclined plate 28 slides along upper surface 22 adjacent end 18 of base 12. Intersections 45 and 47 as springs act to urge inclined plate 28 upwardly to snuggly retain door wedge 10 against lower edge 48 of door 50 thereby retaining door 50 at a user desired position.

Referring to FIG. 4, it is contemplated to interconnect first end 18 of base 12 and first end 30 of inclined surface 28 at intersection 60. As a result, with door wedge 10 slid axially beneath door 50, intersections 45, 47 and 60 act to retain the overall shape of door wedge 10. As such, the resiliency of inclined plate 28 in combination with intersections 45, 47 and 60 act to bias inclined plate 28 against the lower edge 48 of door 50, thereby retaining door 50 at a user desired position.

Referring to FIGS. 5 and 6, a still further embodiment of a door wedge in accordance with the present invention is generally designated by the reference numeral 62. Door wedge 62 includes a generally flat base 64 having first and second sides 66 and 68, respectively, and first and second ends 70 and 72, respectively. Base 64 further includes a generally flat upper surface 74 and a generally flat lower surface 76. A generally flat skid resistant pad 78 is affixed to lower surface 76 of base 64 along the entire length thereof between first and second sides 66 and 68, respectively.

Door wedge 62 further includes generally inclined plate 80 having first and second ends 82 and 84, respectively, and first and second sides 86 and 88, respectively. Inclined plate 80 defined by upper surface 90 and lower surface 92 and includes a plurality of sinusoidal shaped waves 94a-94d that define corresponding lands 96a-96c adjacent thereto. Door wedge 62 further includes a generally vertical wall 98 having a first upper end 100 integral with second end 84 of inclined plate 80 at intersection 102 and a second lower end 104 integral with second ends 72 of base 64 at intersection 106.

In operation, it is intended for door wedge 62 to be positioned between lower edge 48 of conventional door 50 and a supporting surface. Door wedge 62 is slid axially beneath door 50 such that one of lands 96a-96c engages lower edge 48 of door 50. By way of example, lower edge 48 of door 50 engages land 96c in upper surface 90 of inclined surface 80. Intersections 102 and 104 act as springs to urge inclined plate 80 upwardly to snuggly maintain land 96c of door wedge 62 against lower edge 48 of door 50. In addition, wave 94d overlaps the intersection of lower edge 48 and face 56 of door 50 and prevents further pivoting of door 50 from the user desired position.

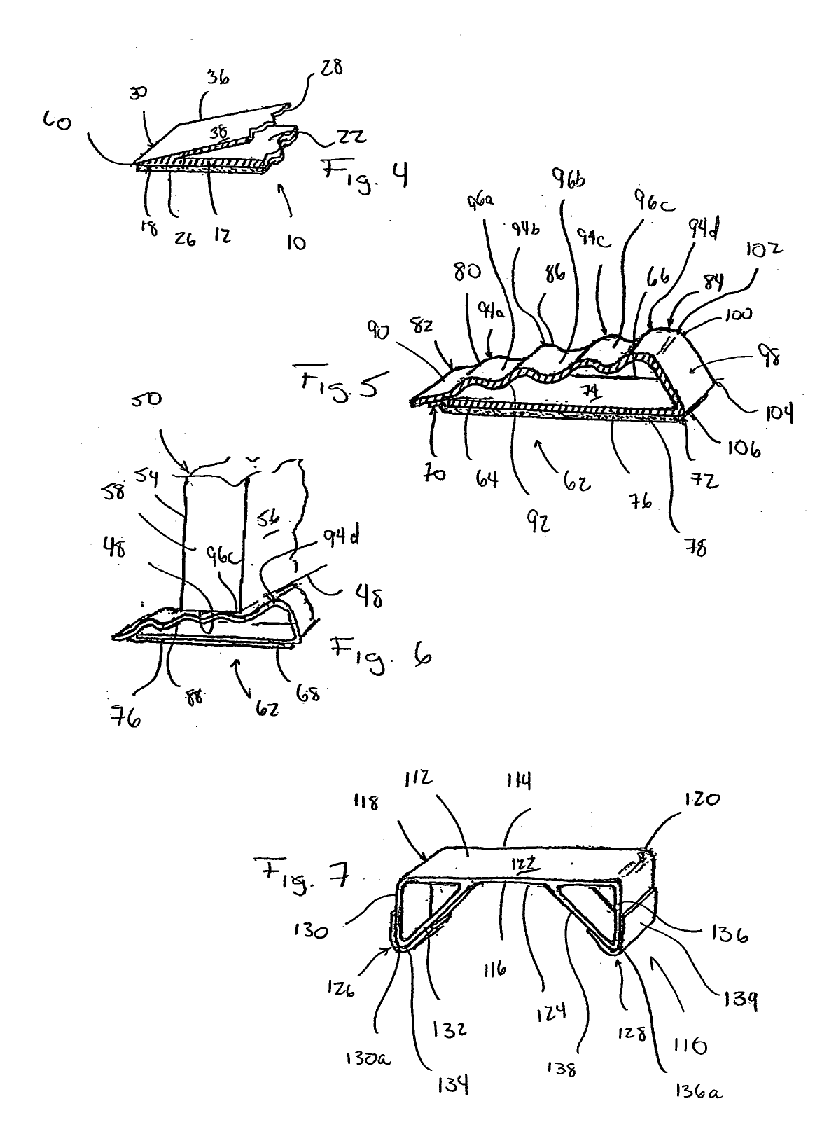

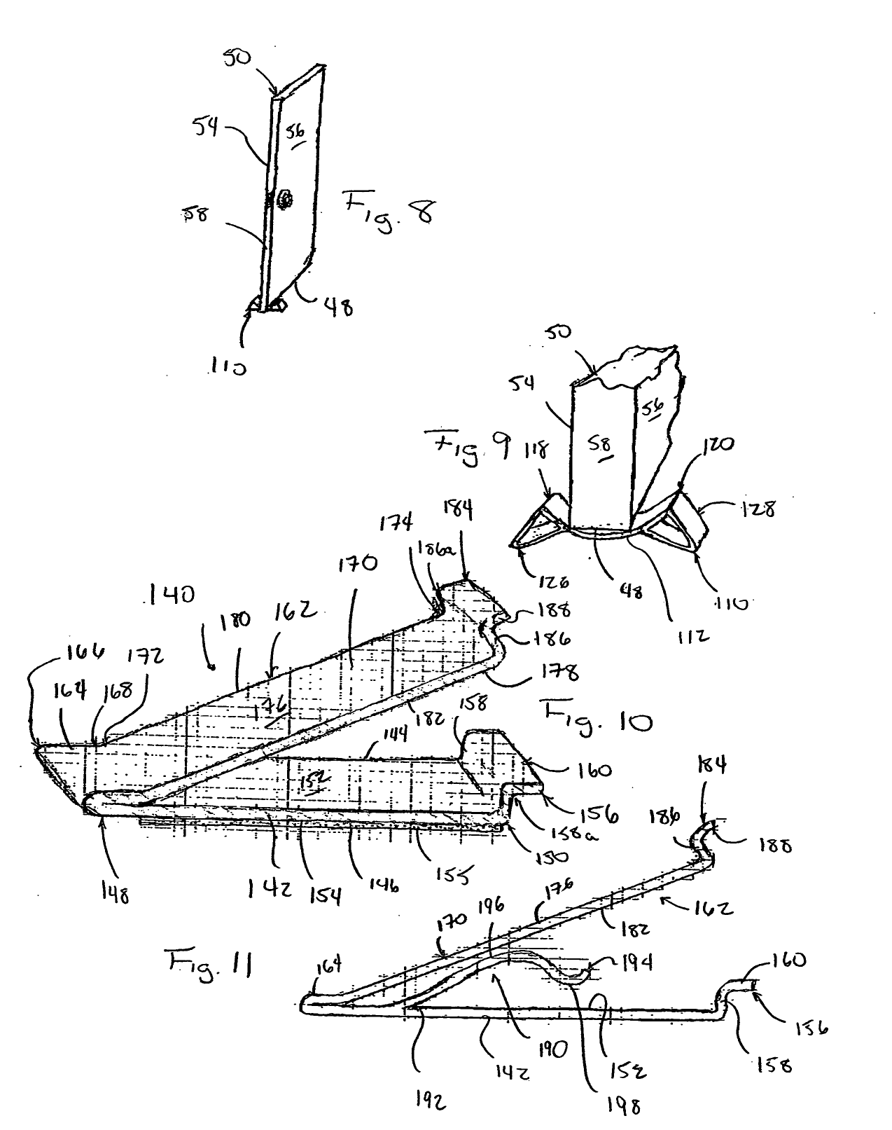

Referring to FIGS. 7-9, a still further embodiment of a door wedge in accordance with the present invention is generally designated by the reference numeral 110. Door wedge 110 includes a generally flat plate 112 defined by first and second sides 114 and 116, respectively, and first and second ends 118 and 120, respectively. Plate 112 further includes a generally flat upper surface 122 and a generally flat lower surface 124. Leg structures 126 and 128 depend from opposite ends of plate 112. Leg structure 126 includes a vertical leg 130 depending from first end 118 of plate 112 and an inclined support leg 132 extending between terminal end 130a of vertical leg 130 and lower surface 124 of plate 112. A skid resistant pad 134 extends about leg structure 126 so as to overlap terminal end 130a of vertical leg 130. Leg structure 128 is defined by vertical wall 136 depending from second end 140 of plate 112 and inclined support leg 138 extending between terminal end 136a of vertical leg 136 and lower surface 124 of plate 112. A skid resistant pad 139 extends about leg structure 128 so as to overlap terminal end 136a of vertical leg 136.

In operation, door 50 is pivoted to a user desired position. Thereafter, leg structures 126 and 128 are urged outwardly, FIG. 9, such that upper surface 122 of plate 112 is generally concave. As a result, door wedge 110 may be slid axially beneath lower edge 48 of door 50. Thereafter, leg structures 126 and 128 are released whereby door wedge 110 attempts to return to its original configuration. As such, upper surface 122 of door wedge 110 engages lower edge 48 of door 50 and snuggly retains door 50 between ends 118 and 120 of plate 112.

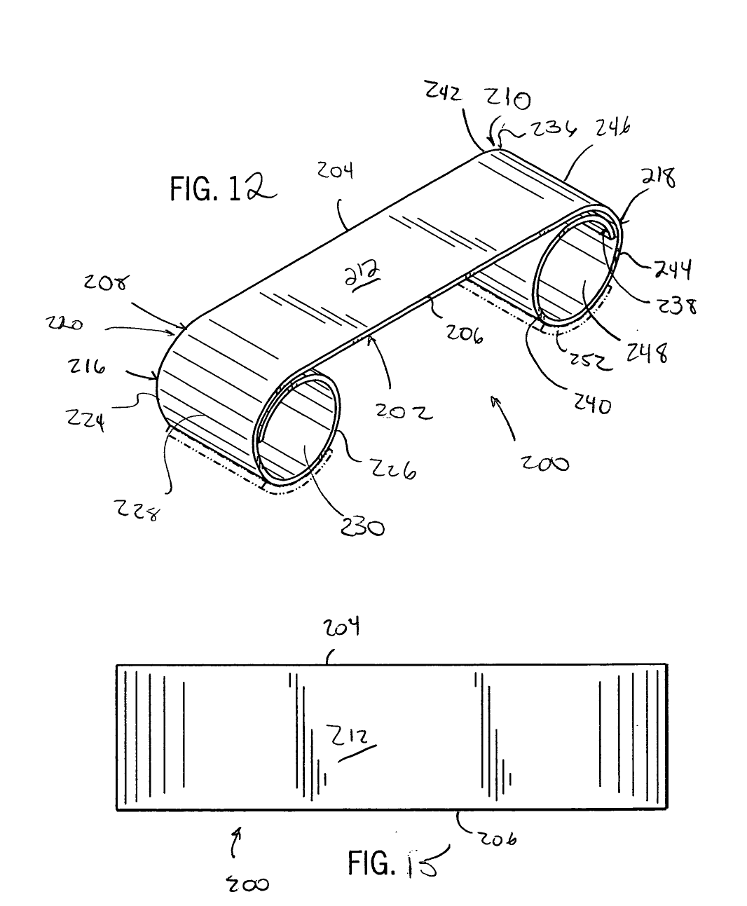

Referring to FIG. 10, a still further embodiment of the door wedge in accordance with the present invention is generally designated by the reference numeral 140. Door wedge 140 includes a generally flat base 142 having first and second sides 144 and 146, respectively, and first and second ends 148 and 150, respectively. Base 142 further includes a generally flat upper surface 152 and a generally flat lower surface 154. A generally flat skid resistant pad 155 is affixed to lower surface 154 of base 142 along the entire length thereof between first and second sides 144 and 146, respectively. A lower grasping element 156 projects from second end 150 of base 142. Lower grasping portion 146 includes a generally vertical leg 158 projecting from second end 150 of base 142 and a grasping leg 160 projecting from terminal end 158a of vertical leg 150 along a plane generally parallel to upper surface 152 of base 142.

Door wedge 140 further include door engaging plate 162 projecting from first end 148 of base 142. Door engaging plate 162 includes a generally flat portion 164 having a first end 166 integral with first end 148 of base 142 and a second opposite end 168. Flat portion 164 of door engaging plate 162 is generally parallel to and overlaps a portion of base 142 adjacent first end 148 thereof. Door engaging plate 162 further includes an inclined portion 170 having a first end 172 integral with second end 168 of flat portion 164 and a second opposite end 174. Inclined portion 170 of door engaging plate 162 further includes upper and lower surfaces 176 and 178, respectively, separated by first and second sides 180 and 182, respectively. Inclined portion 170 of door engaging plate 162 diverges from upper surface 152 of base 142 at a predetermined angle.

Door wedge 140 further includes grasping portion 184 extending from second end 174 of inclined portion 170. Grasping portion 184 include a first leg 186 extending from second end 174 of inclined portion 170 at an angle generally perpendicular thereto. Grasping portion 184 further includes grasping leg 188 extending from terminal end 186a of first leg 186 along a plane generally parallel to upper surface 170. As described, it is intended for a user to grasp grasping portions 184 and 156 in order to urge inclined portion 170 of door engaging plate 162 downwardly towards upper surface 152 of base 142, for reasons hereinafter described.

In operation, door 50 is opened to a user desired position and grasping portions 156 and 184 of door wedge 140 are compressed toward each other so as to urge inclined portion 170 of door engaging plate 162 towards upper surface 152 of base 142. Thereafter, door wedge 140 is slid under door edge 48 of door 50 until such point as face 56 of door 50 engages first leg 186 of grasping portion 184 of door engaging plate 162. Thereafter, grasping portions 156 and 184 of door wedge 140 are released such that inclined portion 170 of door engaging plate 162 returns towards its original configuration such that upper surface 174 of inclined portion 170 engages lower edge 48 of door 50 thereby retaining door wedge 140 in position.

Referring to FIG. 11, in order to provide additional biasing force to urge inclined portion 170 of door engaging portion 162 against lower edge 48 of door 50, it is contemplated to provide spring element 190. Spring element 190 includes a first end 192 integral with and extending from upper surface 152 of base 142 and a second opposite terminal end 194. In addition, spring element 190 further includes a generally arcuate upper surface 196 engageable with lower surface 182 of inclined portion 170 of door engaging plate 162 and a generally arcuate lower surface 198 engageable with upper surface 152 of base 142. As inclined portion 170 of door engaging plate 162 is urged toward upper surface 152 of base 142, upper surface 196 of spring element 190 engages lower surface 182 of inclined portion 170 of door engaging plate 162 and lower surface 198 engages upper surface 152 of base 142 thereby urging inclined portion 170 of door engaging plate 162 back towards its original configuration. Upon release of grasping portions 156 and 184, as heretofore described, spring element 190 acts to urge inclined portion 170 of door engaging plate 162 into engagement with lower edge 48 of door 50.

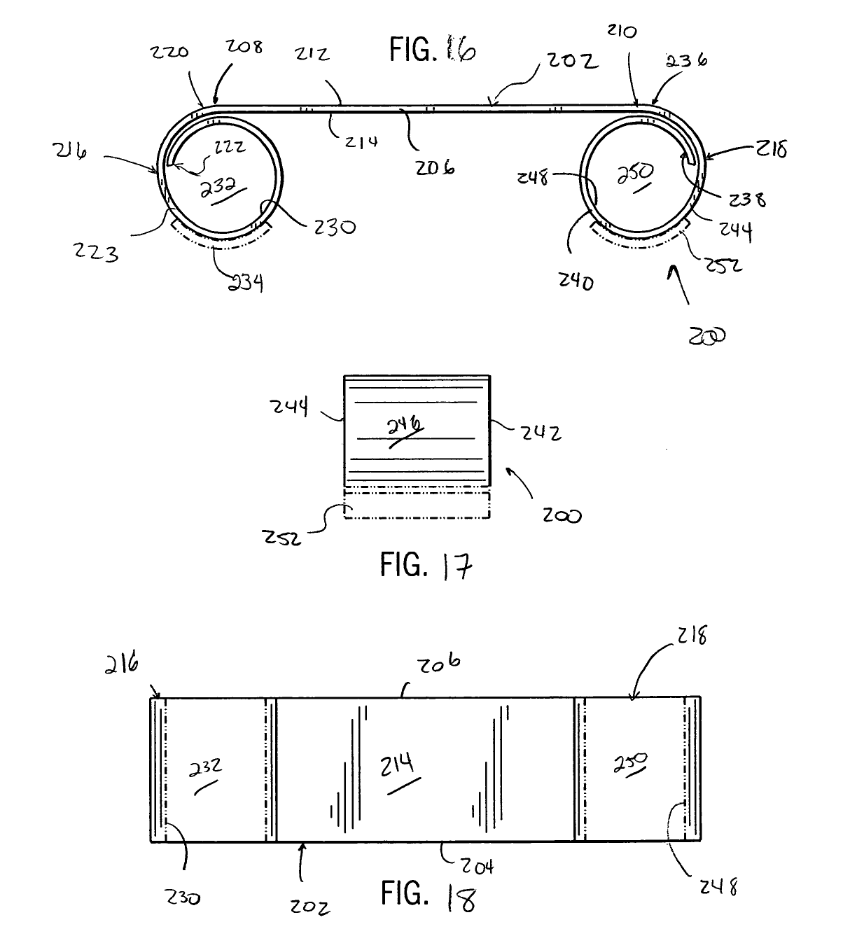

Referring to FIGS. 12-18, a still further embodiment of a door wedge in accordance with the present invention is generally designated by the reference numeral 200. Door wedge 200 includes a generally flat plate or bridge 202 defined by first and second sides 204 and 206, respectively, and first and second ends 208 and 210, respectively. Bridge 202 further includes a generally flat upper surface 212 and a generally flat lower surface 214. First and second tubular support structures 216 and 218, respectively, are operatively connected to corresponding first and second ends 208 and 210, respectively, of bridge 202, as hereinafter described.

First support structure 216 includes a first end 220 integrally formed with first end 208 of bridge 202 and a second free end 222. First support structure 216 also includes a generally arcuate intermediate portion 223 disposed between first and second ends 220 and 222, respectively, thereof. First support structure 216 is defined by first and second sides 224 and 226, respectively, as well as, by outer surface 228 and inner surface 230. It can be appreciated that first side 224 of first support structure 216 lies in a common plane with first side 204 of bridge 202. Similarly, second side 226 of first support structure 216 lies in a common plane with second side 206 of bridge 202. First support structure 216 has a generally tubular configuration such that inner surface 230 of first support structure 216 defines first passageway 232 that extends along an axis generally perpendicular to the longitudinal axis of bridge 202. As described, second end 222 of first support structure 216 is positioned adjacent first end 220 of first support structure 216. It is contemplated to provide skid resistant pad 234 on a portion of outer surface 228 of intermediate portion 223 of first support structure 216, for reasons hereinafter described.

Second support structure 218 includes a first end 236 integrally formed with second end 210 of bridge 202 and a second free end 238. Second support structure 218 also includes a generally arcuate intermediate portion 240 disposed between first and second ends 236 and 240, respectively, thereof. Second support structure 218 is defined by first and second sides 242 and 244, respectively, as well as, by outer surface 246 and inner surface 248. It can be appreciated that first side 242 of second support structure 218 lies in a common plane with first side 204 of bridge 202. Similarly, second side 244 of second support structure 218 lies in a common plane with second side 206 of bridge 202. First support structure 216 has a generally tubular configuration such that inner surface 248 of second support structure 218 defines second passageway 250 that extends along an axis generally perpendicular to the longitudinal axis of bridge 202. As described, second end 238 of second support structure 218 is positioned adjacent first end 236 of second support structure 218. It is contemplated to provide skid resistant pad 252 on a portion of outer surface 246 of intermediate portion 240 of second support structure 218, for reasons hereinafter described.

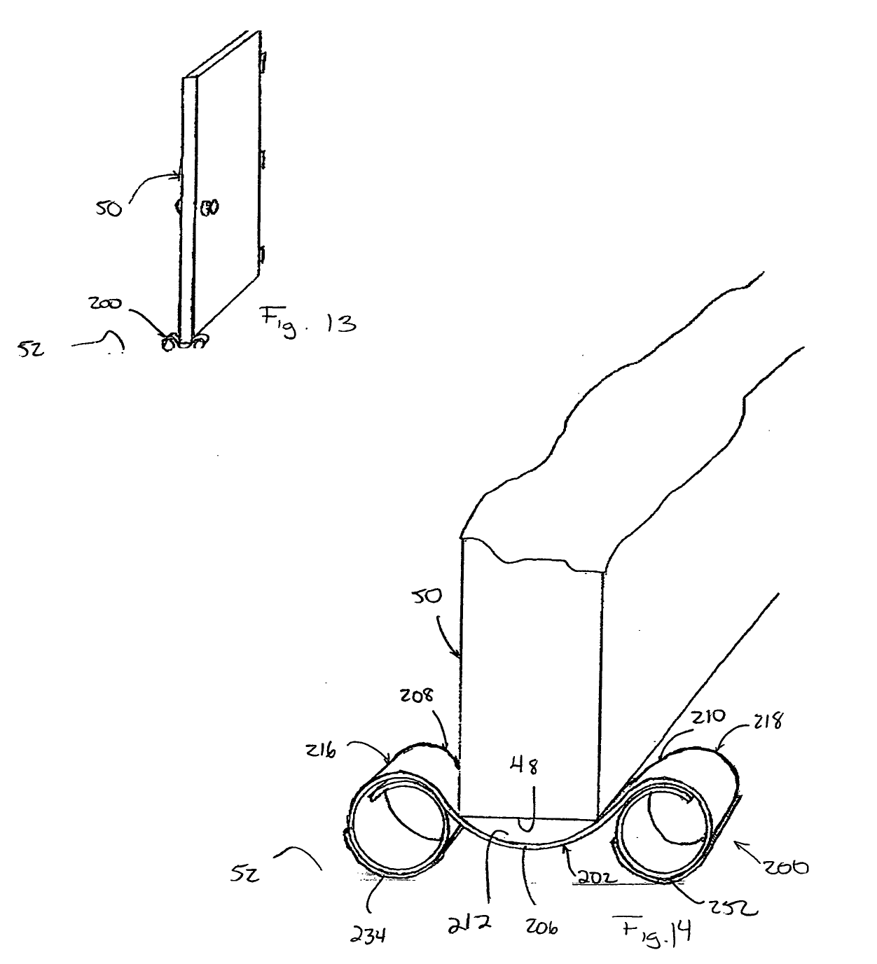

In operation, door 50 is pivotable to a user desired position over a supporting surface 52. Thereafter, bridge 202 is depressed from its generally flat configuration, FIGS. 12 and 15-18 to a crescent shaped configuration, FIGS. 13-14. In other words, upper surface 212 of bridge 202 is generally concaved. Consequently, door wedge 200 may be slid axially beneath lower edge 48 of door 50 and such that skid resistant pads 234 and 252 engage supporting surface 52. Thereafter, upper surface 212 of bridge 202 is released such that bridge 202 is biased by first and second support structures 216 and 218 towards its flat configuration. As a result, upper surface 212 of door wedge 200 engages lower edge 48 of door 50 and snuggly retains door 50 between first and second ends 208 and 210 of bridge 202. Skid resistant pads 234 and 252 prevent longitudinal and axial movement of door wedge 200 along supporting surface 52, thereby maintaining door 50 in the user desired position.

Various modes of carrying out the invention are contemplated as being within the scope of the following claims particularly pointing out and distinctly claiming the subject matter which is regarded as the invention.

1. A door wedge for maintaining a door at a user desired position, the door pivotable over a supporting surface between an open position and a closed position, comprising:
a flexible bridge extending along a bridge axis and having an upper surface for engaging a bottom surface of the door and a lower surface, the bridge including first and second opposite ends;
a first support operatively connected to a first end of the bridge and having a passageway extending therethrough along a first support axis generally perpendicular to the bridge axis; and
a second support operatively connected to the second end of the bridge and having a passageway extending therethrough along a second support axis generally perpendicular to the bridge axis.

2. The door wedge of claim 1 wherein the first support axis is generally parallel to the second support axis.

3. The door wedge of claim 1 wherein the bridge is movable between a first flexed configuration wherein the bridge has a generally crescent shaped cross-section and a second non-flexed position wherein the bridge is generally flat.

4. The door wedge of claim 1 wherein the first support has a first end integral with the first end of the bridge and a second free end and wherein the second support has a first end integral with the second end of the bridge and a second free end.

5. The door wedge of claim 4 wherein the second free end of the first support is positioned adjacent to the first end of the first support and wherein the second free end of the second support is positioned adjacent to the first end of the second support.

6. The door wedge of claim 4 wherein the first support includes an intermediate portion between the first and second ends thereof and wherein the second support includes an intermediate portion between the first and second ends thereof, the intermediate portion of the first support and the intermediate portion of the second support having a generally arcuate cross-section.

7. The door wedge of claim 6 further comprising a first resilient pad affixed to the intermediate portion of the first support for engagement with the supporting surface and a second resilient pad affixed to the intermediate portion of the second support for engagement with the supporting surface.

8. A door wedge for maintaining a door at a user desired position, the door pivotable over a supporting surface between an open position and a closed position, comprising:
a flexible bridge extending along a bridge axis and having an upper surface for engaging a bottom surface of the door and a lower surface, the bridge including first and second opposite ends and being movable between a first flexed configuration wherein the bridge has a generally crescent shaped cross-section and a second non-flexed position wherein the bridge is generally flat;
a first support having a first end operatively connected to a first end of the bridge, a second free end disposed beneath the first end of the first support, and an intermediate portion therebetween; and
a second support having a first end operatively connected to the second end of the bridge, a second free end disposed beneath the first end of the second support and an intermediate portion therebetween.

9. The door wedge of claim 8 wherein the first support defines a passageway therethrough along a first support axis generally perpendicular to the bridge axis.

10. The door wedge of claim 8 wherein the second support defines a passageway therethrough along a second support axis generally perpendicular to the bridge axis and generally parallel to first support axis.

11. The door wedge of claim 8 wherein the first end of the first support is integral with the first end of the bridge and wherein the first end of the second support is integral with the second end of the bridge.

12. The door wedge of claim 8 wherein the intermediate portion of the first support and the intermediate portion of the second support have generally arcuate cross-sections.

13. The door wedge of claim 8 further comprising a first resilient pad affixed to the intermediate portion of the first support for engagement with the supporting surface and a second resilient pad affixed to the intermediate portion of the second support for engagement with the supporting surface.

14. A door wedge for maintaining a door at a user desired position, the door pivotable over a supporting surface between an open position and a closed position, comprising:
a flexible bridge extending along a bridge axis and having an upper surface for engaging a bottom surface of the door and a lower surface, the bridge including first and second opposite ends and being movable between a first flexed configuration wherein the bridge has a generally crescent shaped cross-section and a second non-flexed position wherein the bridge is generally flat;
a first generally cylindrical support having a first end operatively connected to a first end of the bridge, a second free end disposed beneath the first end of the first support, an arcuate intermediate portion therebetween, an inner surface and outer surface;
a first anti-skid structure along the outer surface of the intermediate portion of the first support;
a second generally cylindrical support having a first end operatively connected to the second end of the bridge, a second free end disposed beneath the first end of the second support, an arcuate intermediate portion therebetween, an inner surface and an outer surface; and
a second anti-skid structure along the outer surface of the intermediate portion of the second support.

15. The door wedge of claim 14 wherein the inner surface of the first support defines a passageway therethrough along a first support axis generally perpendicular to the bridge axis.

16. The door wedge of claim 15 wherein the second support defines a passageway therethrough along a second support axis generally perpendicular to the bridge axis and generally parallel to first support axis.

17. The door wedge of claim 14 wherein the first end of the first support is integral with the first end of the bridge and wherein the first end of the second support is integral with the second end of the bridge.

18. The door wedge of claim 14 wherein the first anti-skid structure includes a first resilient pad affixed to the intermediate portion of the first support for engagement with the supporting surface.

19. The door wedge of claim 14 wherein the second anti-skid structure includes a second resilient pad affixed to the intermediate portion of the second support for engagement with the supporting surface.
